(19) United States
(12) Patent Application Publication
(10) Pub. No.: US 2013/0159172 A1
(43) Pub. Date: Jun. 20, 2013

(54) ONLINE REMITTANCE SYSTEM AND METHOD USING MOBILE TERMINAL TO PROVIDE TIPPING SERVICE OR SUPPORT SERVICE

(71) Applicant: Ho Sup Kim, Seongnam (KR)

(72) Inventor: Ho Sup Kim, Seongnam (KR)

(21) Appl. No.: 13/711,184

(22) Filed: Dec. 11, 2012

(30) Foreign Application Priority Data
Dec. 14, 2011 (KR) 10-2011-134481
Nov. 26, 2012 (KR) 10-2012-0134163

(51) Int. Cl. G06Q 20/08

(52) U.S. Cl. CPC G06Q 20/08
USPC 705/39

(57) ABSTRACT

The present invention relates to a recognition means for a targeted recipient who will receive payments, and to an online remittance system and method that perform micro-payment by scanning or directly entering the recognition means, so that a predetermined amount of money can be automatically remitted to a targeted tip recipient or a targeted support recipient.

In a method of providing a tipping service in a remittance management server, a tipping payment request signal including at least one of information about a targeted tip recipient and information about recognition means is received. A payment account of the targeted tip recipient is checked using the targeted tip recipient information or the recognition means information. An amount of money corresponding to amount information included in the tipping payment request signal is paid to the payment account of the targeted tip recipient using payment means selected by a customer.

### CROSS-REFERENCE TO RELATED APPLICATIONS

This application claims under 35 U.S.C. §119(a) the benefit of Korean Application No. 10-2011-134481 filed Dec. 14, 2011 and Korean Application No. 10-2012-0134163 filed Nov. 26, 2012, which applications are incorporated herein by reference.

### BACKGROUND OF THE INVENTION

1. Field of the Invention

The present invention relates, in general, to an online remittance system and method using a mobile terminal to provide a tipping service or a support service and, more particularly, to a targeted tip recipient recognition means which is issued by a financial institution, such as a bank or a credit card company by which an account associated with the recognition means can be opened, or issued by a service subject who operates the system, and to an online remittance system and method using a mobile terminal, which process micro-payment by scanning or directly entering the targeted tip recipient recognition means, so that a predetermined tip can be automatically provided to the corresponding targeted tip recipient, thus improving convenience and economic efficiency.

2. Description of the Related Art

As is well known to those skilled in the art, with the development of recent information and communication technology, information provision technology has been actively developed in which information about various fields is provided in real time to a plurality of subscribers through at least one host server over a long-range data communication network.

Based on this technology, peripheral technology such as cache memory extension technology for more rapidly providing accurate information to subscribers, and information selection technology and compression technology for enabling more convenient access to the tastes and preferences of subscribers are currently being developed. The development of various types of content based on such technologies and solutions thereof has also accelerated.

In any developing country where production and consumption are balanced, the economy is developed to follow the patterns of more advanced countries, but a phenomenon which occurs in Western advanced countries to a larger extent than in Oriental countries, from a cultural standpoint, is that an expression of appreciation for the provision of a service is directly given as cash called a “tip”.

That is, advanced countries have made tipping culture a way of life, and this culture is formed to ultimately inspire service providers to further show kindness, and thus it can be considered that such a culture is also beneficial to the persons provided with services.

However, unlike in Western advanced countries, in Oriental countries, and Korea in particular, people are not accustomed to tipping when paying for a service, so that even if a person provided with a service desires to give the service provider a small amount of money as a tip, it is not customary for them to do so.

Further, there is a problem in that it is difficult for a service provider to receive a tip because the service provider may not be accustomed to receiving tips from people who have been provided with services and may then feel embarrassed, and the service provider may also misunderstand the intensions of a tipper. Furthermore, even if the service provider receives tips, he or she still feels uncomfortable because receiving tips is an unaccustomed action.

Meanwhile, even in the case of advanced countries, when a service provider receives a tip including coins, it is inconvenient for the service provider to work due to the jingling of coins in his or her pocket, or the inconvenience of carrying the coins around.

### SUMMARY OF THE INVENTION

Accordingly, the present invention has been made keeping in mind the above problems occurring in the prior art, and an object of the present invention is to provide a targeted tip recipient recognition means which is issued by a financial institution, such as a bank or a credit card company by which an account associated with the recognition means can be opened, or issued by a service subject who operates the system, and to provide an online remittance system and method using a mobile terminal to provide a tipping service, which process micro-payment by scanning or directly entering the targeted tip recipient recognition means, so that a predetermined tip can be automatically provided to the corresponding targeted tip recipient, thus improving convenience and economic efficiency.

Another object of the present invention is to provide a targeted support recipient recognition means which is issued by a financial institution, such as a bank or a credit card company by which an account associated with the recognition means can be opened, and to provide an online remittance system and method using a mobile terminal to provide a support service, which process micro-payment by scanning or directly entering the targeted support recipient recognition means, so that predetermined support payments can be automatically provided to the corresponding targeted support recipient.

In accordance with an aspect of the present invention to accomplish the above objects, there is provided a method of providing a tipping service in a remittance management server, including receiving a tipping payment request signal including at least one of information about a targeted tip recipient and information about recognition means; checking a payment account of the targeted tip recipient using the targeted tip recipient information or the recognition means information; and allowing an amount of money corresponding to amount information included in the tipping payment request signal to be paid to the payment account of the targeted tip recipient using payment means selected by a customer.

Preferably, the method may further include, if payment has been completed in response to the tipping payment request signal, reporting payment details to the targeted tip recipient, wherein reporting the payment details to the targeted tip recipient is configured such that reporting is performed whenever a payment is completed, or reporting is performed whenever a number of times payment is completed is equal to or greater than a preset number of times.

Preferably, the method may further include, if a message of the customer is included in the tipping payment request signal, reporting the message of the customer to the targeted tip recipient.

Preferably, the method may further include, after the payment has been completed in response to the tipping payment request signal, if an appreciation message desired to be delivered to the customer is received from the targeted tip recipient, delivering the appreciation message to the customer.

Preferably, the method may further include, if evaluation information about the targeted tip recipient or evaluation information about an affiliated store is included in the tipping payment request signal, storing the evaluation information about the targeted tip recipient or the evaluation information about the affiliated store; and analyzing the evaluation information about the targeted tip recipient or the evaluation information about the affiliated store, and then reporting results of the analysis to the targeted tip recipient or a manager of the affiliated store.

Preferably, receiving the tipping payment request signal may be configured to receive a tipping payment request signal generated by a tipping application installed on a mobile terminal, or receive a tipping payment request signal generated via a mobile website or a normal website.

Preferably, the method may further include, before receiving the tipping payment request signal, generating the recognition means that is unique information matching the payment account of the targeted tip recipient.

Preferably, the recognition means may include, as information required to identify the targeted tip recipient, at least one of two-dimensional (2D) data such as a barcode or a Quick Response (QR) code, a numerical code including a mobile phone number, a character code, three-dimensional (3D) data, Near Field Communication (NFC) data, and Radio Frequency Identification (RFID).

Preferably, the payment means may be at least one of a mobile phone-based micro-payment service, a credit card payment service, an electronic wallet payment service, an account transfer service, and a point payment service.

Preferably, allowing the amount of money corresponding to the amount information to be paid to the payment account of the targeted tip recipient may include, if an upper limit amount of a tip is previously set, when the amount of money corresponding to the amount information exceeds the upper limit amount of the tip, outputting the upper limit amount of the tip to the customer and notifying the customer that tipping payment has failed.

In accordance with another aspect of the present invention to accomplish the above objects, there is provided a method of providing a tipping service in a tipping application, including obtaining at least one of information about a targeted tip recipient and information about recognition means; receiving amount information corresponding to a tip from a customer; allowing the customer to determine payment means; generating a tipping payment request signal including at least one of the targeted tip recipient information and the recognition means information, the amount information, and the determined payment means; transmitting the tipping payment request signal to a remittance management server; and paying an amount of money corresponding to the amount information via the determined payment means.

Preferably, the recognition means may include, as information required to identify the targeted tip recipient, at least one of two-dimensional (2D) data such as a barcode or a Quick Response (QR) code, a numerical code including a mobile phone number, a character code, three-dimensional (3D) data, Near Field Communication (NFC) data, and Radio Frequency Identification (RFID).

Preferably, obtaining at least one of the targeted tip recipient information and the recognition means information may be configured to scan the recognition means via a scanning device included in a mobile terminal and obtain the recognition means information.

Preferably, the method may further include receiving a message of the customer desired to be delivered to the targeted tip recipient, wherein generating the tipping payment request signal is configured such that the message of the customer is included in the tipping payment request signal, upon generating the tipping payment request signal.

Preferably, the method may further include receiving evaluation information about the targeted tip recipient or evaluation information about an affiliated store, wherein generating the tipping payment request signal is configured such that the evaluation information about the targeted tip recipient or the evaluation information about the affiliated store is included in the tipping payment request signal, upon generating the tipping payment request signal.

Preferably, the tipping application may be installed on a mobile terminal or can be provided in a form of a mobile website or a normal website.

Preferably, the method may further include, after paying the amount of money, if an appreciation message created by the targeted tip recipient is received from the remittance management server, outputting the appreciation message.

In accordance with a further aspect of the present invention to accomplish the above objects, there is provided an online remittance system using a mobile terminal, including a mobile terminal for scanning or receiving information about recognition means of a targeted tip recipient, and generating a tipping payment request signal so that a tip corresponding to a predetermined amount of money is automatically transferred into an account of a specific targeted tip recipient matching the recognition means information; and a remittance management server for registering the recognition means information, managing an account of the targeted tip recipient corresponding to the recognition means information, and allowing the tip corresponding to the predetermined amount of money to be transferred into the account of the targeted tip recipient via payment means in response to the tipping payment request signal.

Preferably, the remittance management server may classify and manage the recognition means information for respective affiliated stores.

Preferably, the remittance management server may receive evaluation information about the targeted tip recipient or evaluation information about the affiliated store from the mobile terminal, and manage the received evaluation information.

Preferably, the recognition means may be either generated and issued by the remittance management server, or generated and issued by a financial server that manages the account of the targeted tip recipient.

In accordance with yet another aspect of the present invention to accomplish the above objects, there is provided a remittance management server for providing a tipping service, including a reception unit for receiving a tipping payment request signal including at least one of information about a targeted tip recipient and information about recognition means; an analysis unit for checking a payment account of the targeted tip recipient using the targeted tip recipient information or the recognition means information, and checking amount information included in the tipping payment request signal and payment means selected by a customer; and a payment gateway unit for allowing an amount of money corresponding to the amount information to be paid to the payment account of the targeted tip recipient via the payment means.

Preferably, the remittance management server further include a recognition means generation management unit for generating recognition means matching the targeted tip recipient information and managing information about the recognition means.

Preferably, the remittance management server may further include an evaluation information management unit for managing evaluation information about the targeted tip recipient or a targeted affiliated store to which a tip is to be provided, for respective affiliated stores or for respective targeted tip recipients.

In accordance with still another aspect of the present invention to accomplish the above objects, there is provided an online remittance system using a mobile terminal, including a mobile terminal for scanning or receiving information about recognition means of a targeted support recipient, and generating a support payment request signal so that predetermined support payments are automatically transferred into an account of a specific targeted support recipient matching the recognition means information; and a remittance management server for registering the recognition means information, managing an account of the targeted support recipient corresponding to the recognition means information, and allowing the predetermined support payments to be transferred into the account of the targeted support recipient via payment means in response to the support payment request signal.

### BRIEF DESCRIPTION OF THE DRAWINGS

FIG. 1 is a block diagram schematically showing the configuration of an online remittance system using a mobile terminal according to an embodiment of the present invention;

FIG. 2 is a diagram showing the state of the confirmation of a recognition means by the online remittance system using a mobile terminal according to an embodiment of the present invention;

FIG. 3 is a diagram showing the state of processing of tipping by the online remittance system using a mobile terminal according to an embodiment of the present invention;

FIG. 4 is a diagram showing the state of issuance of a targeted tip recipient recognition means when a tipping service is provided using the online remittance system using a mobile terminal according to an embodiment of the present invention;

FIG. 5 is a block diagram showing the configuration of a remittance management server included in the online remittance system using a mobile terminal according to an embodiment of the present invention;

FIG. 6 is a flowchart schematically showing a tipping processing procedure performed by the online remittance system using a mobile terminal according to an embodiment of the present invention;

FIG. 7 is a flowchart showing a recognition means issuance procedure performed by the online remittance system using a mobile terminal according to an embodiment of the present invention;

FIG. 8 is a flowchart showing a recognition means information checking procedure performed by the online remittance system using a mobile terminal according to an embodiment of the present invention;

FIG. 9 is a flowchart showing the tipping processing procedure in detail; and

FIG. 10 is a diagram showing the state of issuance of a targeted support recipient recognition means when a support service is provided using the online remittance system using a mobile terminal according to an embodiment of the present invention.

### DETAILED DESCRIPTION OF EMBODIMENTS

The above and other objects, features and advantages of the present invention will be more clearly understood from the following detailed description taken in conjunction with the accompanying drawings.

Hereinafter, preferred embodiments of the present invention will be described in detail with reference to the attached drawings. In the description of the present invention, detailed descriptions of related known components or functions that may unnecessarily make the gist of the present invention obscure will be omitted.

However, the present invention is neither restricted nor limited by those embodiments. Throughout the different drawings, the same reference numerals presented in the drawing are used to designate the same components.

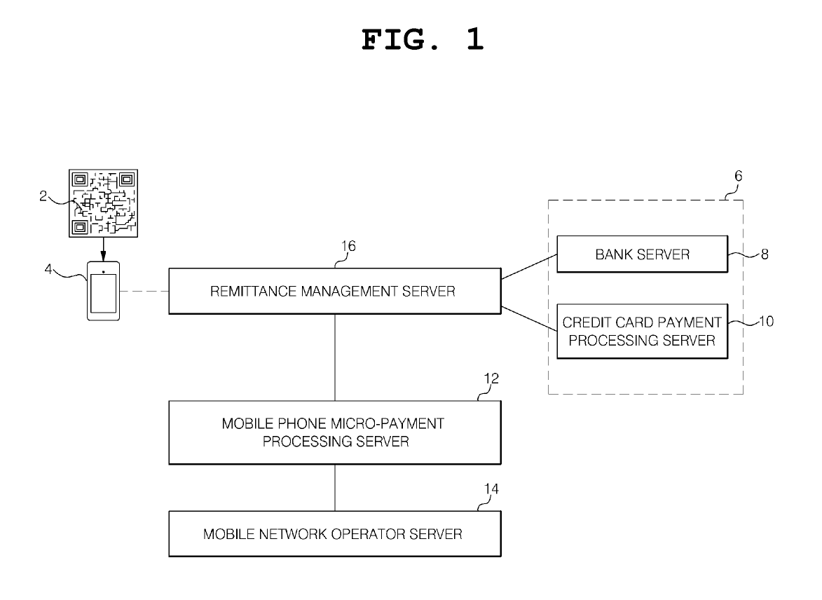

Hereinafter, an online remittance system and method using a mobile terminal to provide a tipping or support service according to embodiments of the present invention will be described in detail with reference to FIGS. 1 to 10.

The remittance system of the present invention can be applied both to a tipping service and to a support service. However, in the detailed description of the present invention, a description will be made mainly based on a method of providing a tipping service using the remittance system.

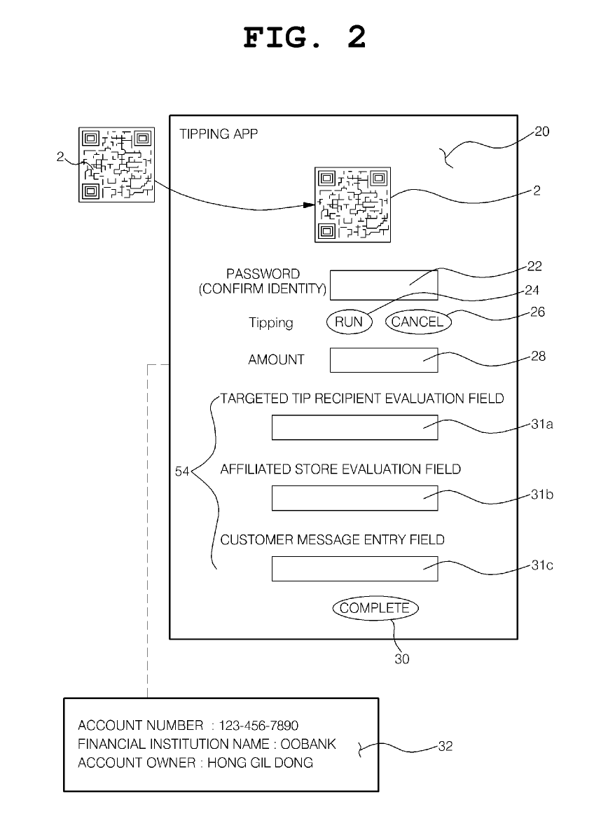

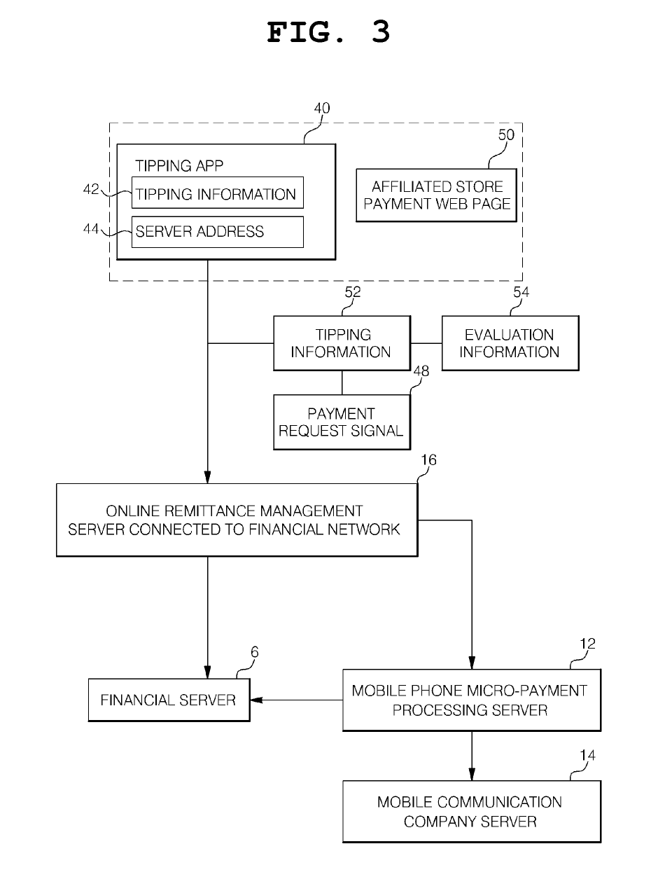

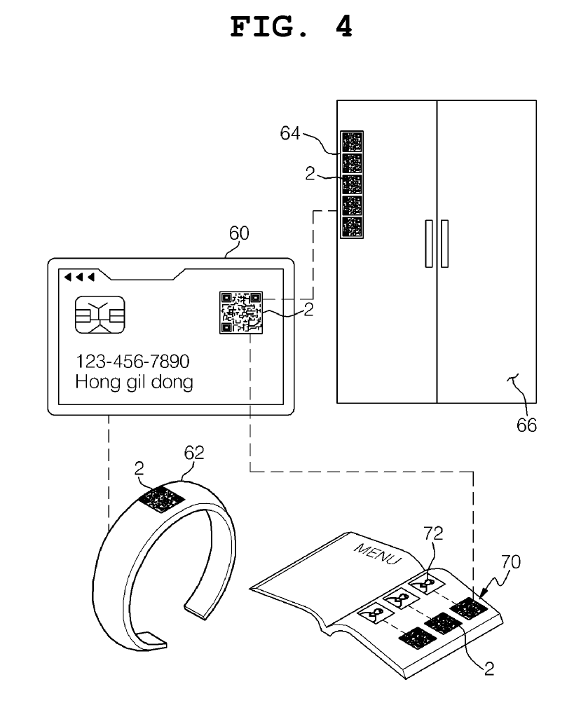

FIG. 1 is a block diagram schematically showing the configuration of an online remittance system using a mobile terminal according to an embodiment of the present invention, FIG. 2 is a diagram showing the state of the confirmation of a recognition means by the online remittance system using a mobile terminal according to an embodiment of the present invention, FIG. 3 is a diagram showing the state of processing of tipping by the online remittance system using a mobile terminal according to an embodiment of the present invention, and FIG. 4 is a diagram showing the state of issuance of a targeted tip recipient recognition means when a tipping service is provided using the online remittance system using a mobile terminal according to an embodiment of the present invention.

Referring to the drawings, a remittance management server for providing a tipping service, an online remittance system using a mobile terminal, and a tipping application according to an embodiment of the present invention denote a server, a system, and an application that process micro-payment by scanning or directly entering a predetermined targeted tip recipient recognition means issued by a financial institution, such as a bank or a credit card company by which an account associated with the recognition means can be opened, so that a predetermined tip can be automatically provided to the corresponding targeted tip recipient, thus improving convenience and economic efficiency.

In more detail, the online remittance system using the mobile terminal according to an embodiment of the present invention includes a mobile terminal 4 and a remittance management server 16. The mobile terminal 4 scans or receives information about a targeted tip recipient recognition means, and generates a tipping payment request signal to automatically transfer a tip corresponding to a predetermined amount of money to the account of a specific targeted tip recipient that matches the recognition means information. The remittance management server 16 registers the recognition means information, manages the account of the targeted tip recipient corresponding to the recognition means information, and causes the tip corresponding to the predetermined amount of money to be transferred into the account of the targeted tip recipient via a payment means in response to the tipping payment request signal.

Preferably, the mobile terminal 4 may be a Long-Term Evolution (LTE) 4th Generation (4G) smart phone enabling Wireless Fidelity (WiFi) communication to enable the rapid transmission/reception of data and the processing of large-capacity data, but the mobile terminal of the present invention is not limited thereto, and any type of mobile tablet PC or tablet pad, such as an iPad, can also be used.

Further, a targeted tip recipient recognition means 2 is a means that is used to identify an employee, a clerk, an affiliated store, etc. that are targeted recipients capable of receiving a tip by providing services, and that matches or includes the account of the corresponding targeted tip recipient as hidden information. Information required to identify each targeted tip recipient includes at least one of two-dimensional (2D) data such as a barcode or a Quick Response (QR) code, a numerical code including a mobile phone number, a character code, 3D data, Near Field Communication (NFC) data, and Radio Frequency Identification (RFID).

In this case, the targeted tip recipient may be an individual including an employee, a clerk, a worker, or a supervisor, or may be a business including an affiliated store, and the targeted tip recipient is not especially limited to a specific form.

Preferably, the targeted tip recipient recognition means 2 denotes unique information matching a unique account, and may be attached or printed on any one of a credit card 60, a bracelet or watch 62, and a name card, as shown in FIG. 4.

Further, as shown in FIG. 4, the targeted tip recipient recognition means 2 may be printed or attached on a notice paper 64, such as a poster, on the door 66 or the wall of an affiliated store, or may be attached or printed on a menu board 70. It is more preferable that the targeted tip recipient recognition means 2 be displayed together with picture information 72 disposed besides the targeted tip recipient recognition means 2.

Furthermore, the online remittance system using the mobile terminal according to an embodiment of the present invention includes a financial server 6 that opens the account of each targeted tip recipient, and issues and processes information about the targeted tip recipient recognition means matching the account, wherein the financial server 6 may include a bank server 8 or a credit card payment processing server 10.

Furthermore, the targeted tip recipient recognition means 2 may be issued by a financial institution, but may also be issued by the remittance management server 16. If the targeted tip recipient recognition means 2 is issued by the financial institution, the registration and information management of the targeted tip recipient recognition means 2 is performed by the remittance management server 16, and the payment gateway processing thereof is also processed by the remittance management server 16.

Meanwhile, the remittance management server 16 included in the online remittance system using the mobile terminal according to an embodiment of the present invention may perform the management or alignment of pieces of information about the targeted tip recipient recognition means 2 by classifying targeted tip recipient recognition means for respective affiliated stores.

Of course, the processing of tipping payment by the online remittance system using the mobile terminal according to an embodiment of the present invention may be carried out to include various types of payment means or payment schemes. The remittance management server 16 performs payment gateway processing, but it is also possible to configure the system such that the remittance management server 16 is not engaged in payment processing, and this configuration is also included in the gist of the present invention.

In greater detail, the online remittance system using the mobile terminal according to an embodiment of the present invention is configured such that a user provided with a service may select any one from among various types of payment means including payment using various cards including credit cards, account transfer, micro-payment, and point payment, and may request payment from the remittance management server 16. The remittance management server 16 is connected to the financial server 6 including the bank server 8 or the credit card payment processing server 10.

Furthermore, when the user selects micro-payment based on a mobile phone, the remittance management server 16 is connected to a mobile phone micro-payment processing server 12 and a mobile network operator server 14. In this case, the mobile phone micro-payment processing server 12 is a server configured in a well-known company, such as ‘DANAL Co., Ltd.’, and performs payment processing such that a payment amount is included in mobile phone fees to be subsequently charged. Accordingly, the mobile phone micro-payment processing server 12 is connected to the mobile network operator server 14 and performs processing such that tipping payment amount information is transmitted to the mobile network operator server 14 and obtains approval for payment.

Furthermore, in the mobile terminal 4 included in the online remittance system using the mobile terminal according to an embodiment of the present invention, a tipping application 4 is installed. The tipping application 4 is configured such that when the targeted tip recipient recognition means 2 is input, the tipping application 4 automatically transmits information about the corresponding targeted tip recipient recognition means 2 to a specific Uniform Resource Locator (URL) and generates a payment request signal. For example, when the tipping application 40 is executed, a main screen 20 as shown in FIG. 2 is displayed.

On the main screen 20 of the tipping application 40, a scanned targeted tip recipient recognition means 2 is displayed, a password input box 22 allowing a person issued with the recognition means 2 (for example, a targeted tip recipient) to personally check the information included in the targeted tip recipient recognition means 2 is provided, a tipping execution button 24 and a cancel button 26 are individually provided, and an input box 28 enabling an amount of money to be entered is provided.

That is, a clerk or an employee who is a targeted tip recipient can determine whether a targeted tip recipient recognition means 2 printed on a name card or the like has exactly matched his or her account, by inputting a password. It is preferable to prevent some accounts from being accessed for privacy or for the protection of personal financial information.

Meanwhile, it is also possible to perform settings such that even a clerk or an employee who is a targeted tip recipient cannot check account information. However, if tipping processing has been executed, it is preferable to transmit tipping processing information to the mobile terminal of the corresponding targeted tip recipient and allow the targeted tip recipient to check the tipping processing information.

Further, on the main screen 20 of the tipping application 40, a field enabling evaluation information 54 to be additionally entered or selected is present. The evaluation information 54 includes in detail a targeted tip recipient evaluation field 31a, an affiliated store evaluation field 31b, and a customer message entry field 31c. A completion button 30 is disposed below the evaluation information 54.

Information entered or selected via the targeted tip recipient evaluation field 31a, the affiliated store evaluation field 31b, and the customer message entry field 31c is transmitted to and managed by the remittance management server 16, and it is possible to classify, manage, and align the information for respective affiliated stores and targeted tip recipients.

Further, if tipping processing has been completed, the remittance management server 16 reports payment details via various types of means, such as the previously registered email of each targeted tip recipient, a short message, and a multimedia message. With regard to the time at which the payment details are reported to the targeted tip recipient, the payment details can be reported whenever payment is completed or only when the number of times payment is completed is equal to or greater than the preset number of times.

Upon reporting the payment details, if the message of a customer is included in the tipping payment request signal, the remittance management server 16 can report the customer's message to the targeted tip recipient. After payment has been completed in response to the tipping payment request signal, when an appreciation message desired to be delivered to the customer is received from the targeted tip recipient, it is possible to perform processing such that the appreciation message is delivered to the customer.

Meanwhile, if evaluation information about the corresponding targeted tip recipient or evaluation information about the corresponding affiliated store is included in the tipping payment request signal, the remittance management server 16 stores the evaluation information about the targeted tip recipient or about the affiliated store, analyzes the evaluation information about the targeted tip recipient or about the affiliated store, and reports the results of the analysis to the targeted tip recipient or the manager of the affiliated store.

Further, the user provided with a service from a clerk or an employee who is a targeted tip recipient may request tipping processing via the tipping application 40. An amount of money to be provided as a tip (tip amount) may be previously set, or may be input whenever a tipping processing signal is generated.

Meanwhile, when the tip amount is previously set via the tipping application 40, or when the tip amount is input each time, an upper limit amount can be previously set. In this case, the remittance management server 16 processes payment such that when the tip amount exceeds the upper limit amount, the corresponding payment is denied.

In this case, the tipping application 40 installed on the mobile terminal 4 is designated to automatically transmit tipping information 52 including information about the corresponding targeted tip recipient recognition means to the remittance management server 16 when payment processing request information 48 or micro-payment request information is generated. This function is intended by the remittance management server 16 to subsequently evaluate the service of the affiliated store or the like, and the corresponding evaluation information is preferably provided to the owner of the affiliated store or an affiliated enterprise.

By this operation, the remittance management server 16 uploads service class information for respective affiliated stores so that the service class information can be accessed, thus allowing users desiring to visit the corresponding affiliated store to refer to the service evaluation information, and allowing the owner of the affiliated store to manage the quality of services based on the class information.

Further, the remittance management server 16 can provide information about the number of times that a targeted tip recipient received a tip or an amount of money that has been received as the tip so that the owner of the affiliated store or users desiring to visit the corresponding affiliated store can refer to the service evaluation information. In this case, the number of times that the tip has been received, or the amount of money that has been received as the tip, can be updated at regular intervals.

Meanwhile, the online remittance system using the mobile terminal according to an embodiment of the present invention may process payment for tipping by personally selecting a specific targeted tip recipient from the payment web page 50 of the affiliated store, in addition to mobile phone-based micro-payment.

The tipping application 40 transmits tipping information 42 that is extracted via the targeted tip recipient recognition means 2 and that is combined with input tip amount information. Information about a destination, for example, the address 44 of a specific server, is previously stored, so that the corresponding tipping information 42 is transmitted to the address 44 of the server. The server address is the address of the server that processes micro-payment.

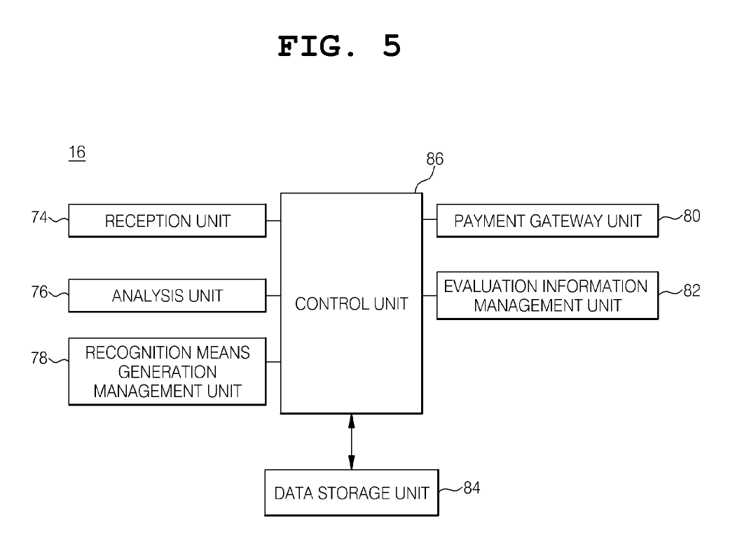

FIG. 5 is a block diagram showing the configuration of the remittance management server included in the online remittance system using the mobile terminal according to an embodiment of the present invention.

Referring to FIG. 5, the remittance management server 16 included in the online remittance system using the mobile terminal according to an embodiment of the present invention includes a reception unit 74, an analysis unit 76, and a payment gateway unit 80. The reception unit 74 receives a tipping payment request signal including at least one of information about each targeted tip recipient and information about each recognition means. The analysis unit 76 checks the payment account of the targeted tip recipient using the targeted tip recipient information or the recognition means information, and checks tip amount information included in the tipping payment request signal and a payment means selected by the customer. The payment gateway unit 80 processes payment such that an amount of money corresponding to the tip amount information is paid to the payment account of the targeted tip recipient via the payment means.

The remittance management server 16 may further include a recognition means generation management unit 78 and an evaluation information management unit 82. The recognition means generation management unit 78 generates a recognition means that matches information about each targeted tip recipient and manages information about the recognition means. The evaluation information management unit 82 manages evaluation information about a targeted tip recipient or an affiliated store to which a tip is to be given, for respective affiliated stores or respective targeted tip recipients.

The remittance management server 16 further includes a control unit 86 for controlling the driving or processing of the reception unit 74, the analysis unit 76, the recognition means generation management unit 78, the payment gateway unit 80, the evaluation information management unit 82, and a data storage unit 84 which perform respective functions. Further, the remittance management server 16 includes the data storage unit 84 for storing pieces of information about recognition means, targeted tip recipients, and accounts in relation with one another while also storing information about affiliated stores and evaluation information.

The functions and operations of the online remittance system using the mobile terminal according to the embodiment of the present invention having the above configuration will be described in detail with reference to the attached drawings.

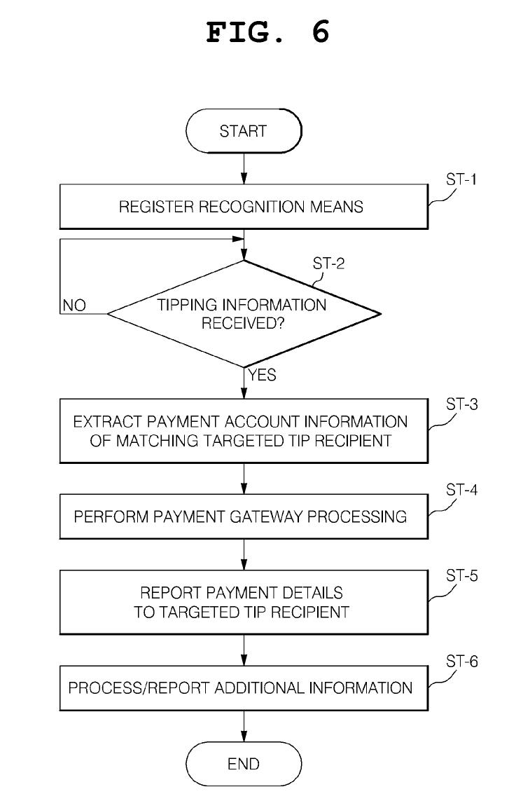

FIG. 6 is a flowchart schematically showing a tipping processing procedure performed by the online remittance system using the mobile terminal according to an embodiment of the present invention.

First, the online remittance system using the mobile terminal according to an embodiment of the present invention registers the recognition means of each targeted tip recipient, which is associated with the account information of the targeted tip recipient and for which a user provided with a service requests payment for a tip, in a financial institution or the remittance management server 16.

In this state, the remittance management server 16 determines whether a tipping payment request signal including at least one of the targeted tip recipient information and recognition means information has been received. If it is determined that the tipping payment request signal has been received, the payment account of the targeted tip recipient is checked using the targeted tip recipient information or the recognition means information.

Further, the remittance management server 16 performs payment gateway processing so that an amount of money corresponding to amount information included in the tipping payment request signal is paid to the payment account of the targeted tip recipient via a payment means selected by a customer.

Next, the remittance management server 16 reports payment details to the corresponding targeted tip recipient. As described above, the remittance management server 16 can report such payment details to the targeted tip recipient using various types of schemes, such as a short message, a multimedia message, email, or Automatic Response System (ARS).

Furthermore, the remittance management server 16 separately manages additional information, for example, information about the evaluation of each targeted tip recipient, the evaluation of each affiliated store, and other types of evaluation, classifies the evaluation information for respective targeted tip recipients or for respective affiliated stores, and reports such classified evaluation information.

In this case, the recognition means includes, as information required to identify each targeted tip recipient, at least one of 2D data such as a barcode or a Quick Response (QR) code, a numerical code including a mobile phone number, a character code, 3D data, Near Field Communication (NFC) data, and RFID.

Furthermore, the payment means includes at least one of a mobile phone-based micro-payment service, a credit card service, and an account transfer service. The payment means is a payment means processed by the remittance management server 16 and enables various types of payment gateway processing.

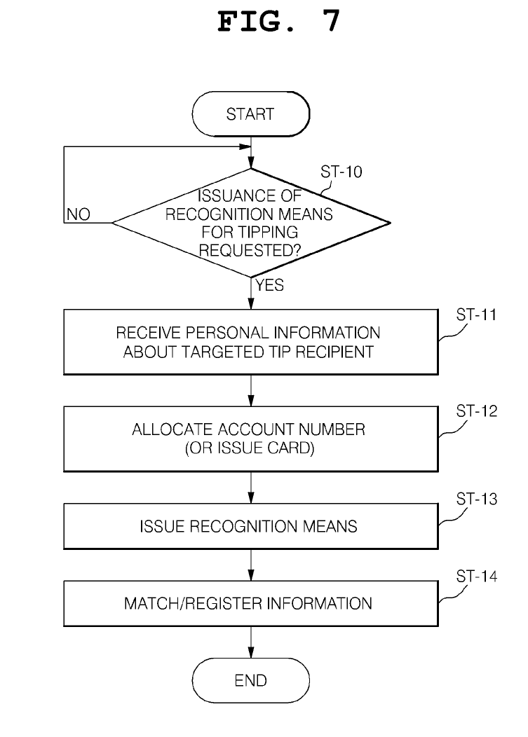

FIG. 7 is a flowchart showing a recognition means issuance procedure performed by the online remittance system using the mobile terminal according to an embodiment of the present invention.

First, the remittance management server 16 included in the online remittance system using the mobile terminal according to an embodiment of the present invention must generate the recognition means, which is unique information matching the payment account of the targeted tip recipient, and register the information before receiving a tipping payment request signal.

That is, since the recognition means of the targeted tip recipient that is a principal component included in the online remittance system using the mobile terminal according to an embodiment of the present invention is scanned or entered to provide a tip online, the recognition means must be stored with the recognition means linked to account number information that enables a tip to be received, or must include therein account number information.

Therefore, a procedure in which the clerk or employee of an affiliated store visits a financial institution and a targeted tip recipient who is a service provider opens an account and requests the issuance of a targeted tip recipient recognition means must be performed.

This procedure generally includes the step of opening an account in the financial institution. Therefore, based on the procedure of receiving the personal information of a targeted tip recipient, assigning an account number, and opening an account, the present invention issues a targeted tip recipient recognition means implemented as a code or the like including the corresponding account number, and provides the corresponding account number, personal information, and targeted tip recipient recognition means so that they match one another.

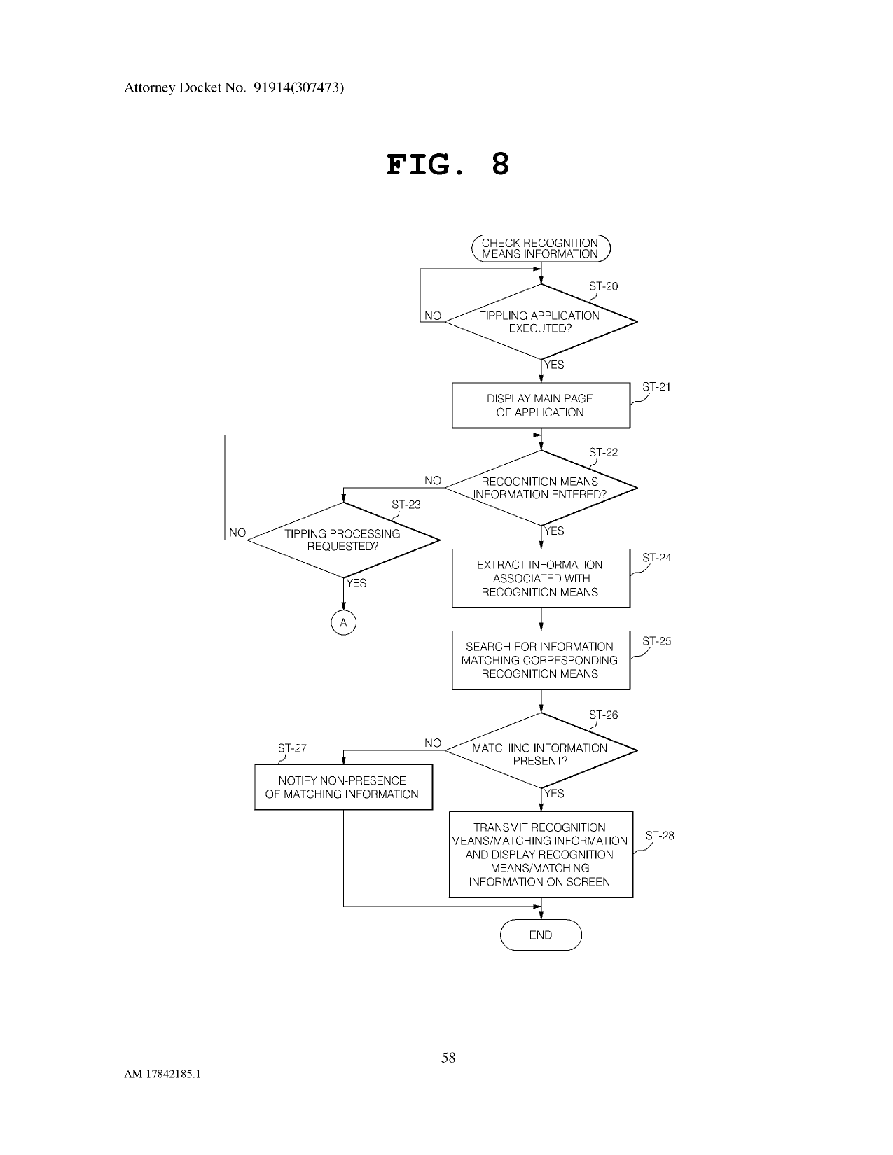

FIG. 8 is a flowchart showing a recognition means information checking procedure performed by the online remittance system using the mobile terminal according to an embodiment of the present invention.

First, the recognition means information checking procedure performed by the online remittance system using the mobile terminal according to an embodiment of the present invention is an additional procedure. The owner of an affiliated store may be previously issued a recognition means and may update only account information matching the corresponding recognition means by changing information stored in the remittance management server 16 whenever a new worker is employed.

When the management of this recognition means information is possible, the targeted tip recipient must be able to determine whether account information has been set to exactly match recognition means.

As shown in the drawing, the online remittance system using the mobile terminal according to an embodiment of the present invention can perform the procedure of allowing a clerk or an employee who can receive a tip by providing a service to check information about the targeted tip recipient recognition means 2 printed on a name card or a bracelet worn on the clerk or the employee.

That is, for this operation, the clerk or the employee must install the tipping application 40 on the mobile terminal 4, and must execute the tipping application 40.

When the tipping application 40 is executed, the main page of the application is displayed on the screen of the mobile terminal 4.

Then, the tipping application 40 determines whether information about a recognition means has been input, and if it is determined that the recognition means has been input, the tipping application 40 extracts information associated with the recognition means.

More exactly, hidden information concealed in the recognition means 2 of the targeted tip recipient can be extracted. In this case, the tipping application 40 can authenticate whether the corresponding user is a person capable of accessing the hidden information included in the recognition means 2 of the targeted tip recipient. After authentication has been completed by transmitting a password, a resident registration number, and a mobile phone number to the remittance management server 16, if it is determined that the user is an authentic user, the remittance management server 16 transmits an access approval signal to the corresponding tipping application 40, thus enabling the hidden information to be accessed.

Preferably, information that can be checked by allowing the targeted tip recipient to scan or directly enter his or her targeted tip recipient recognition means may be an account number, the name of a financial institution, information about the owner of an account. More preferably, for personal financial security, part of the account number may be processed so as not to be accessed.

In contrast, in the case where information matching or included in the targeted tip recipient recognition means 2 is not present, the corresponding account number is closed. Accordingly, it is also preferable that the remittance management server 16 transmit the account information when the online remittance system using the mobile terminal according to an embodiment of the present invention accesses tipping-related information or processes tipping.

In this case, when only the account number is closed, the problem of transferring an amount of money into an incorrect account or it being impossible to normally pay a tip even if the targeted tip recipient recognition means 2 associated with the account number is present can be solved. However, this corresponds to contents that can be changeable within the range of gist of the present invention, and thus a detailed description thereof will be omitted.

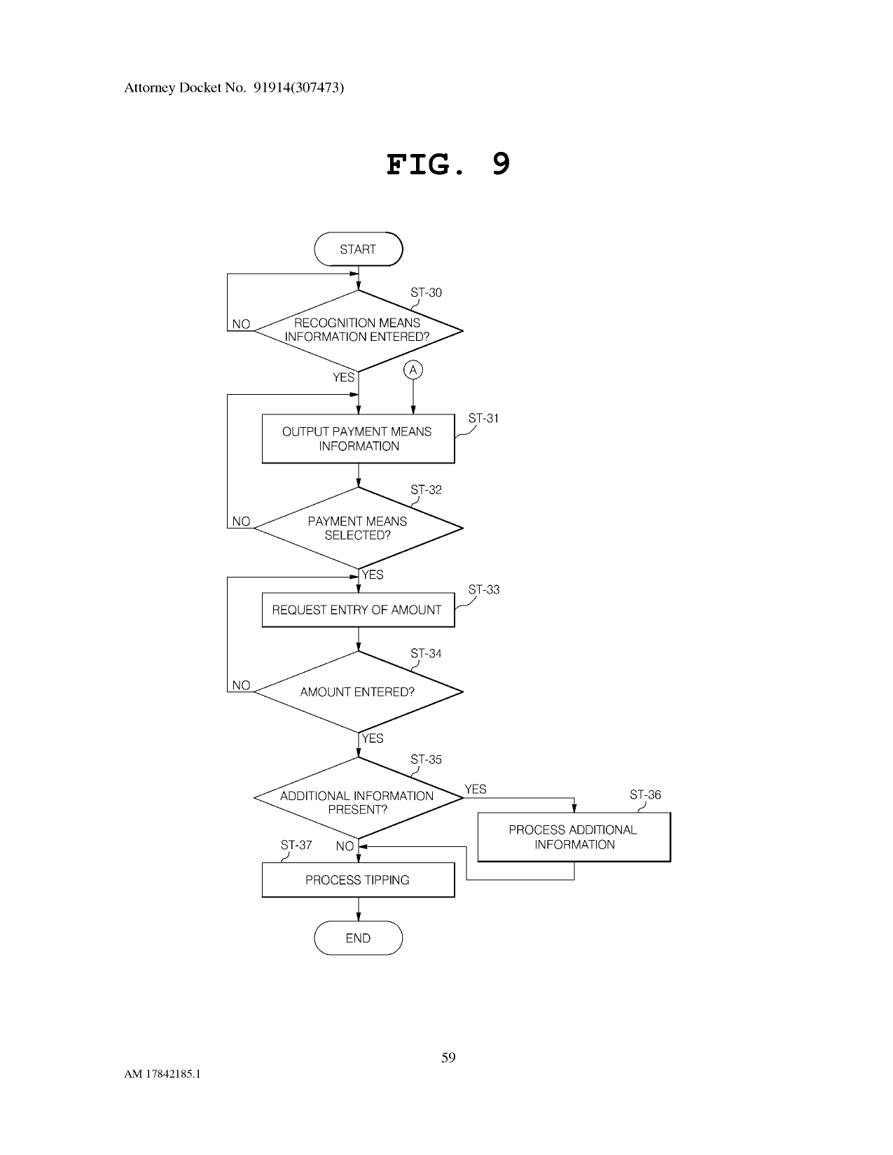

FIG. 9 is a flowchart showing a tipping processing procedure in detail.

First, a procedure must be performed in which the clerk or employee of an affiliated store visits a financial institution, and then a targeted tip recipient who is a service provider opens an account and requests the issuance of a targeted tip recipient recognition means.

This procedure generally includes the step of opening an account in the financial institution. Therefore, based on the procedure of receiving the personal information of a targeted tip recipient, assigning an account number, and opening an account, the present invention issues a targeted tip recipient recognition means implemented as a code or the like including the corresponding account number, and provides the corresponding account number, personal information, and targeted tip recipient recognition means so that they match one another.

That is, the service provider, that is, the targeted tip recipient, visits a financial institution, opens an account, and requests the issuance of a targeted tip recipient recognition means.

Due thereto, the financial server 6 performs processing to open the account of the targeted tip recipient, issue the targeted tip recipient recognition means, and then register the corresponding information.

Thereafter, the clerk or the employee who is the targeted tip recipient provides a service, and can separately indicate that the corresponding store is an affiliated store enabling online tipping processing.

Therefore, in order to perform tipping processing, a user provided with a service can download a tipping application from the remittance management server 16 and install the tipping application. Once the tipping application has been installed, it can be used in another affiliated store.

For this, the user provided with the service executes the tipping application, and scans and enters the recognition means 2 of the targeted tip recipient printed on the name card or the like of the employee through the tipping application.

Further, the user can generate a tipping payment request signal through the tipping application, and a tip is transferred into the account associated with the recognition means of the corresponding targeted tip recipient.

In this case, in order to request tipping processing, the user must enter information about an amount of money to be provided as a tip, and select payment means information, such as for credit card payment, account transfer, mobile phone-based micro-payment, or point payment. Therefore, the remittance management server 16 receives such payment request information, and performs payment gateway processing.

Meanwhile, it is also sufficiently possible for the user to request the processing of account transfer, credit card payment, or point payment, on the payment page of the affiliated store, in addition to the mobile phone-based micro-payment. Even in the case of mobile phone-based micro-payment, payment is processed by transmitting a payment request signal to the mobile phone micro-payment processing server 12 via the remittance management server 16. In the case of credit card payment, the remittance management server 16 issues a payment request signal to a Value Added Network (VAN) company server.

Further, when a tipping processing signal is generated, the mobile terminal 4 of the user can transmit information about the targeted tip recipient recognition means to the remittance management server 16. In this case, when the service class of the affiliated store is selected, the remittance management server 16 can accumulatively register the service class selected by the user for respective affiliated stores and can evaluate services for respective affiliated stores.

Further, when tipping processing is completed, the remittance management server 16 can report payment details via various types of means, such as the previously registered email of the targeted tip recipient, a short message, or a multimedia message. With regard to the time at which the payment details are reported to the targeted tip recipient, the payment details can be reported whenever payment is completed or only when the number of times payment is completed is equal to or greater than the preset number of times.

Upon reporting the payment details, if the message of a customer is included in the tipping payment request signal, the remittance management server 16 can report the customer's message to the targeted tip recipient. After payment has been completed in response to the tipping payment request signal, when an appreciation message desired to be delivered to the customer is received from the targeted tip recipient, the remittance management server 16 can perform processing such that the appreciation message is delivered to the customer.

Meanwhile, when evaluation information about the targeted tip recipient or evaluation information about the affiliated store is included in the tipping payment request signal, the remittance management server 16 stores the evaluation information about the targeted tip recipient or about the affiliated store, analyzes the evaluation information about the targeted tip recipient or about the affiliated store, and then reports the results of the analysis to the targeted tip recipient or the manager of the affiliated store.

Further, the user provided with the service from the clerk or the employee who is the targeted tip recipient can request tipping processing via the tipping application 40, and can previously set an amount of money to be provided as a tip (tip amount) and enter the amount of money whenever a tipping processing signal is generated.

When the tip amount is previously set via the tipping application 40 or when the tip amount is entered each time, an upper limit amount can be previously set. When the tip amount is input and exceeds the upper limit amount, the remittance management server 16 processes payment such that the corresponding payment is not approved.

Meanwhile, the remittance system of the present invention can also be applied to support services for targeting support.

When the support service is provided using the remittance system, a targeted tip recipient in the above embodiment may be replaced with a targeted support recipient, a user may be replaced with a supporter, and a tip may be replaced with support payments.

Further, the evaluation information of the evaluation information management unit 82 may be replaced with communication information. In this case, the communication information is information for communication between a supporter and a targeted support recipient, or between a supporter and a group to which a targeted support recipient belongs. Such communication information may include information required to evaluate the certain action of the targeted support recipient or evaluate a group to which the targeted support recipient belongs, and information, such as messages desired by a supporter to deliver to the targeted support recipient.

For example, when the targeted support recipient is a politician, the communication information may include information about the evaluation of the policies of the corresponding politician, information about the evaluation of a political party to which the politician belongs, information about hopes on the politician, etc.

Meanwhile, the targeted support recipient may be an individual such as an entertainer, an unfortunate neighbor, a poor child, a handicapped child, a child breadwinner, or a senior citizen who lives alone, or a group such as a political party, a religious community, an orphan school, or an entertainment management company. Further, the targeted support recipient may be a targeted person having an anniversary or an event, such as an infant having a first birthday, elders celebrating their 70th or 80th birthdays, bride and groom getting married, or a person arranging a funeral. In addition, any targeted person may be the targeted support recipient without many limitations.

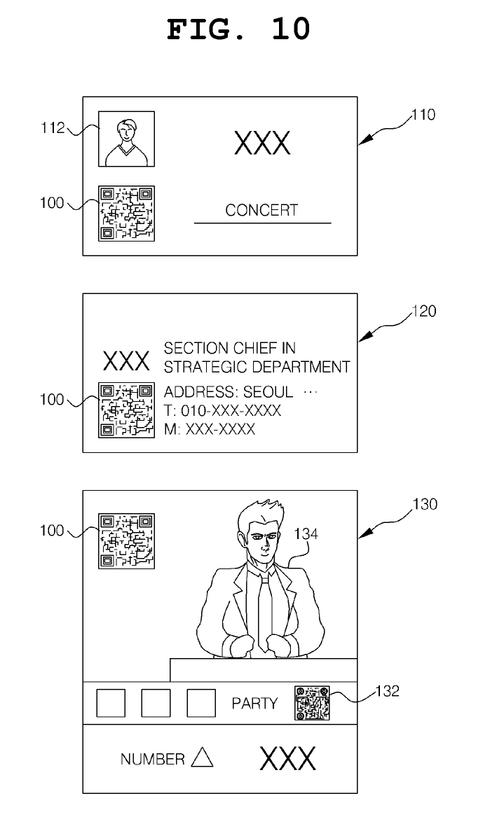

When the support service is provided using the remittance system, the targeted tip recipient recognition means 2 can be replaced with a targeted support recipient recognition means 100, and can be applied, as shown in the example of FIG. 10.

FIG. 10 is a diagram showing the issuance of a targeted support recipient recognition means when the support service is provided by the online remittance system using the mobile terminal according to an embodiment of the present invention.

Referring to FIG. 10, the targeted support recipient recognition means 100 may be attached or printed on any one of an invitation 110, a name card 120, a campaign poster 130, or various types of printed matter.

Further, as shown in the campaign poster 130, the targeted support recipient recognition means 100 may be printed together with the recognition means 132 of a group to which a targeted support recipient belongs, and may preferably be indicated around the targeted support recipient recognition means 100, together with picture information 112 and 134.

Meanwhile, when the support service is provided using the remittance system, the targeted support recipient may request the cancellation of support if support is received from an undesired supporter. Then, the remittance management server 16 that received a support cancellation request may cancel the payment of support payments and may notify the supporter of the cancellation of the payment of support payments.

As described above, the present invention relates to a recognition means for a targeted recipient who will receive payments, and to an online remittance system and method that perform micro-payment by scanning or directly entering the recognition means issued by a financial institution, such as a bank or a credit card company by which an account associated with the recognition means can be opened, so that a predetermined amount of money can be automatically remitted to the corresponding targeted tip recipient or the corresponding targeted support recipient.

When a tipping service is provided using the remittance system of the present invention, there is an advantage in that a tip corresponding to a relatively small amount of money can be easily exchanged, so that a culture of expressing appreciation for the provision of a service can be easily integrated into Oriental culture, and a small amount of money can be automatically transferred into designated accounts without being inconveniently exchanged, thus improving the convenience of tipping.

When the support service is provided using the remittance system of the present invention, there is an advantage in that a support procedure can be simplified, and a supporter's message or the like is added when support payments are transferred, thus enabling communication to be performed between the supporter and a targeted support recipient.

The online remittance system and method using the mobile terminal according to embodiments of the present invention may be implemented in the form of program instructions that are executable by various types of computer means, and may be recorded in a computer-readable storage medium. The computer-readable storage medium may include program instructions, data files, and data structures either independently or in combination. The program instructions stored in the medium may be designed and configured especially for the present invention or may be known to and usable by those skilled in the art of computer software. Examples of the computer-readable storage medium may include a magnetic medium such as a hard disk, a floppy disk, or magnetic tape, an optical medium such as Compact Disk-Read Only Memory (CD-ROM) or a Digital Versatile Disk (DVD), a magneto-optical medium such as a floptical disk, and a hardware device such as ROM, Random Access Memory (RAM), or flash memory which is especially configured to store and execute program instructions. Examples of the program instructions include not only such machine language code as created by a compiler, but also such high-level language code as being executable by a computer using an interpreter or the like. The hardware device can be configured to function as one or more software modules so as to perform the operation of the present invention, and vice versa.

Although the present invention has been described with reference to specific details such as detailed components, limited embodiments, and drawings, these are merely provided to help the complete understanding of the present invention. The present invention is not limited to the embodiments, and those skilled in the art may perform various changes and modifications from the above description of the present invention.

Therefore, the scope of the present invention should not be limited by the above-described embodiments, and it should be understood that the accompanying claims and all equal or equivalent modifications thereof are included in the scope of the spirit of the present invention.

What is claimed is:

1. A method of providing a tipping service in a remittance management server, comprising:
receiving a tipping payment request signal including at least one of information about a targeted tip recipient and information about recognition means;
checking a payment account of the targeted tip recipient using the targeted tip recipient information or the recognition means information; and
allowing an amount of money corresponding to amount information included in the tipping payment request signal to be paid to the payment account of the targeted tip recipient using payment means selected by a customer.

2. The method of claim 1, further comprising, if payment has been completed in response to the tipping payment request signal, reporting payment details to the targeted tip recipient,
wherein reporting the payment details to the targeted tip recipient is configured such that:
reporting is performed whenever a payment is completed, or
reporting is performed whenever a number of times payment is completed is equal to or greater than a preset number of times.

3. The method of claim 1, further comprising, if a message of the customer is included in the tipping payment request signal, reporting the message of the customer to the targeted tip recipient.

4. The method of claim 1, further comprising, after the payment has been completed in response to the tipping payment request signal, if an appreciation message desired to be delivered to the customer is received from the targeted tip recipient, delivering the appreciation message to the customer.

5. The method of claim 1, further comprising:
if evaluation information about the targeted tip recipient or evaluation information about an affiliated store is included in the tipping payment request signal, storing the evaluation information about the targeted tip recipient or the evaluation information about the affiliated store; and
analyzing the evaluation information about the targeted tip recipient or the evaluation information about the affiliated store, and then reporting results of the analysis to the targeted tip recipient or a manager of the affiliated store.

6. The method of claim 1, wherein receiving the tipping payment request signal is configured to:
receive a tipping payment request signal generated by a tipping application installed on a mobile terminal, or
receive a tipping payment request signal generated via a mobile website or a normal website.

7. The method of claim 1, further comprising, before receiving the tipping payment request signal, generating the recognition means that is unique information matching the payment account of the targeted tip recipient.

8. The method of claim 1, wherein the recognition means includes, as information required to identify the targeted tip recipient, at least one of two-dimensional (2D) data such as a barcode or a Quick Response (QR) code, a numerical code including a mobile phone number, a character code, three-dimensional (3D) data, Near Field Communication (NFC) data, and Radio Frequency Identification (RFID).

9. The method of claim 1, wherein the payment means is at least one of a mobile phone-based micro-payment service, a credit card payment service, an electronic wallet payment service, an account transfer service, and a point payment service.

10. The method of claim 1, wherein allowing the amount of money corresponding to the amount information to be paid to the payment account of the targeted tip recipient comprises, if an upper limit amount of a tip is previously set, when the amount of money corresponding to the amount information exceeds the upper limit amount of the tip, outputting the upper limit amount of the tip to the customer and notifying the customer that tipping payment has failed.

11. A method of providing a tipping service in a tipping application, comprising:
obtaining at least one of information about a targeted tip recipient and information about recognition means;
receiving amount information corresponding to a tip from a customer;
allowing the customer to determine payment means;
generating a tipping payment request signal including at least one of the targeted tip recipient information and the recognition means information, the amount information, and the determined payment means;
transmitting the tipping payment request signal to a remittance management server; and
paying an amount of money corresponding to the amount information via the determined payment means.

12. The method of claim 11, wherein the recognition means includes, as information required to identify the targeted tip recipient, at least one of two-dimensional (2D) data such as a barcode or a Quick Response (QR) code, a numerical code including a mobile phone number, a character code, three-dimensional (3D) data, Near Field Communication (NFC) data, and Radio Frequency Identification (RFID).

13. The method of claim 11, wherein obtaining at least one of the targeted tip recipient information and the recognition means information is configured to scan the recognition means via a scanning device included in a mobile terminal and obtain the recognition means information.

14. The method of claim 11, further comprising receiving a message of the customer desired to be delivered to the targeted tip recipient,
wherein generating the tipping payment request signal is configured such that the message of the customer is included in the tipping payment request signal, upon generating the tipping payment request signal.

15. The method of claim 11, further comprising receiving evaluation information about the targeted tip recipient or evaluation information about an affiliated store,
wherein generating the tipping payment request signal is configured such that the evaluation information about the targeted tip recipient or the evaluation information about the affiliated store is included in the tipping payment request signal, upon generating the tipping payment request signal.

16. The method of claim 11, wherein the tipping application can be installed on a mobile terminal or can be provided in a form of a mobile website or a normal website.

17. The method of claim 11, further comprising, after paying the amount of money, if an appreciation message created by the targeted tip recipient is received from the remittance management server, outputting the appreciation message.

18. An online remittance system using a mobile terminal, comprising:
a mobile terminal for scanning or receiving information about recognition means of a targeted tip recipient, and generating a tipping payment request signal so that a tip corresponding to a predetermined amount of money is automatically transferred into an account of a specific targeted tip recipient matching the recognition means information; and
a remittance management server for registering the recognition means information, managing an account of the targeted tip recipient corresponding to the recognition means information, and allowing the tip corresponding to the predetermined amount of money to be transferred into the account of the targeted tip recipient via payment means in response to the tipping payment request signal.

19. The online remittance system of claim 18, wherein the remittance management server classifies and manages the recognition means information for respective affiliated stores.

20. The online remittance system of claim 18, wherein the remittance management server receives evaluation information about the targeted tip recipient or evaluation information about the affiliated store from the mobile terminal, and manages the received evaluation information.

21. The online remittance system of claim 18, wherein the recognition means is either generated and issued by the remittance management server, or generated and issued by a financial server that manages the account of the targeted tip recipient.

22. A remittance management server for providing a tipping service, comprising:
a reception unit for receiving a tipping payment request signal including at least one of information about a targeted tip recipient and information about recognition means;
an analysis unit for checking a payment account of the targeted tip recipient using the targeted tip recipient information or the recognition means information, and checking amount information included in the tipping payment request signal and payment means selected by a customer; and
a payment gateway unit for allowing an amount of money corresponding to the amount information to be paid to the payment account of the targeted tip recipient via the payment means.

23. The remittance management server of claim 22, further comprising a recognition means generation management unit for generating recognition means matching the targeted tip recipient information and managing information about the recognition means.

24. The remittance management server of claim 22, further comprising an evaluation information management unit for managing evaluation information about the targeted tip recipient or a targeted affiliated store to which a tip is to be provided, for respective affiliated stores or for respective targeted tip recipients.

25. An online remittance system using a mobile terminal, comprising:
a mobile terminal for scanning or receiving information about recognition means of a targeted support recipient, and generating a support payment request signal so that predetermined support payments are automatically transferred into an account of a specific targeted support recipient matching the recognition means information; and
a remittance management server for registering the recognition means information, managing an account of the targeted support recipient corresponding to the recognition means information, and allowing the predetermined support payments to be transferred into the account of the targeted support recipient via payment means in response to the support payment request signal.
